(19) United States
(12) Patent Application Publication
(10) Pub. No.: US 2007/0073475 A1
(43) Pub. Date: Mar. 29, 2007

(54) Navigation apparatus and map display device

(76) Inventor: Hideki Endo, Yokohama-city (JP)

Correspondence Address: BRINKS HOFER GILSON & LIONE, P.O. BOX 10395, CHICAGO, IL, 60610, US

(21) Appl. No.: 11/526,836

(22) Filed: Sep. 25, 2006

(30) Foreign Application Priority Data
Sep. 27, 2005 (JP) 2005-279188

(51) Int. Cl. G01C 21/00

(52) U.S. Cl. 701/207

(57) ABSTRACT

A navigation apparatus for simultaneously displaying a first map and a second map which differs from the first map in representation form includes a map display means for displaying the first map and the second map at different display areas of the display, and a position specification accepting means adapted to accept the specification of a position on the display area with the first map being displayed thereon from a user. The map display means is adapted to display the second map in such a form that a position on the second map representing the same point as the point on the first map is identifiable, the point on the first map corresponding to the position whose specification is accepted by the position specification accepting means. This enables the user to easily identify the position of the point on the second map corresponding to the point specified on the first map.

### BACKGROUND

1. Related Applications

The present application claims priority to Japanese Patent Application Number 2005-279188, filed Sep. 27, 2005, the entirety of which is hereby incorporated by reference.

2. Field of the Invention

The invention relates to a technique for simultaneously displaying a plurality of different types of maps in a navigation apparatus or the like, and more particularly to a technique for providing a user with information regarding a point on a displayed map.

3. Description of the Related Art

A technique of map display for simultaneously displaying a plurality of different types of maps in a vehicle-mounted navigation apparatus is known which involves dividing a map display screen into two sub-screens, one of the sub-screens displaying a two-dimensional map covering a geographic range around a position of a vehicle, and the other displaying a three-dimensional map covering a geographic range around the vehicle position (which is displayed such that a user would feel as if the user were looking at a three-dimensional space around the position), as disclosed in, for example, JP-A-No. 2004-347420.

A further display technique for such a navigation apparatus is known which is adapted to display on a three-dimensional map a frame border indicative of a geographic range covered by a two-dimensional map when the geographic range of the two-dimensional map displayed on one sub-screen is smaller than that of the three-dimensional map displayed on the other sub-screen, as disclosed in, for example, JP-A-No. 2002-311817.

Simultaneous display of a plurality of different types of maps may disadvantageously make it difficult for a user to identify readily where one point on one map is located on another map. It should be noted that in the above-mentioned technique, which involves displaying on the three-dimensional map a frame border indicative of the geographic range covered by the two-dimensional map, the user can easily identify a range on the three-dimensional map which corresponds to the range covered by the entire two-dimensional map. However, it is difficult to associate a position of one point on one map with a position of the corresponding point on the other map.

Furthermore, when simultaneously displaying the plurality of different types of maps, the size of display of a map becomes smaller as compared with the case of displaying only one map. Thus, when information about a point on the map designated by the user is provided to the user by being displayed on the map, the amount of information which can be presented to the user with high visibility may be limited.

It is therefore an object of the invention to make it easy for the user to identify the position of a point on the other map corresponding to a point on one map when a plurality of different types of maps is displayed simultaneously. In addition, it is another object of the invention to provide more information about a user-specified point on the map to the user without degrading visibility when a plurality of different types of maps is displayed simultaneously.

### BRIEF SUMMARY

In order to solve the above-mentioned problems, in one aspect of the invention, a navigation apparatus mounted in a vehicle for simultaneously displaying a first map and a second map which differs from the first map in representation form includes a display device, map display means for displaying the first map and the second map at different display areas of the display device, current position calculation means for calculating a current position of the vehicle, current position display means for displaying a current position mark indicative of the current position calculated by the current position calculation means on at least one of the first map and the second map displayed by the map display means, and position specification accepting means adapted to accept the specification of a position on the display area with the first map being displayed thereon from a user. The map display means is adapted to display the second map in such a form that a position on the second map representing the same point as a point on the first map is identifiable, the point on the first map corresponding to the position whose specification is accepted by the position specification accepting means.

With this arrangement, in the navigation apparatus, the second map is displayed in such a form that the position on the second map representing the same point as the point on the first map specified by the user is identifiable. This allows the user to easily identify the position of the point on the second map corresponding to the point on the first map specified by the user.

Preferably, such a navigation apparatus further includes point information display means for displaying information regarding the point on the first map corresponding to the position whose specification is accepted by the position specification accepting means, near the point on the first map within the display area with the first map being displayed thereon. This can provide the user with information about the point of interest specified on the first map by the user so that the user can identify the information in relation to the user-specified point.

When this point information display means is provided, the point information display means preferably displays matter associated with the point on the first map corresponding to the position whose specification is accepted by the position specification accepting means, near the position on the second map representing the same point as the point on the first map corresponding to the position whose specification is accepted by the position specification accepting means, within the display area with the second map being displayed thereon. This can provide the user with information and matter about the point specified by the user on the map, especially about both areas near the point on the first map and near the corresponding point on the second map. Therefore, more information and matter about the point specified by the user can be provided to the user so that the user can identify the information and matter in relation to the point specified by the user without degrading visibility.

In the navigation apparatus described above, the position specification accepting means is configured to accept from the user the specification of the position at any one of the display area with the first map being displayed thereon and the display area with the second map being displayed thereon. When the position specification accepting means accepts the specification of the position at the display area with the second map being displayed thereon, the first map and the second map may be alternated in relation to each other in operating the above-mentioned navigation apparatus. Furthermore, any one of the first map and the second map may be a three-dimensional map, and the other may be a two-dimensional map.

This enables the user to specify the point of interest on either the first map or the second map, whichever is more useful, and to identify the positions on both maps corresponding to the point specified, thereby obtaining the information and matter regarding the point.

In the above-mentioned navigation apparatus, the first map may be the three-dimensional map, and the second map may be the two-dimensional map. In this case, when the position specification accepting means accepts the specification of the position on the display area with the first map being displayed thereon, the map display means may display the second map in such a form that a predetermined mark is disposed at a position on the second map representing the same point as the point on the first map which corresponds to the position whose specification is accepted by the position specification accepting means. At this time, the map display means may display the second map in such a form that a facility existing at the point on the first map corresponding to the position whose specification is accepted by the position specification accepting means is displayed and emphasized with a graphic on the second map.

This can provide the user with the point and the facility on the second map corresponding to the point on the first map which corresponds to the position whose specification is accepted by the position specification accepting means so that the user can identify the point and facility through intuition.

In the above-mentioned navigation apparatus, in a case where the first map is the three-dimensional map and the second map is the two-dimensional map, when the position specification accepting means accepts the specification of the position on the display area with the first map being displayed thereon, the map display means may display the second map in the following form. A graphic displayed at the position on the first map whose specification is accepted by the position specification accepting means may represent a facility disposed at the point on the first map corresponding to the position whose specification is accepted by the position specification accepting means, and a predetermined mark may be disposed at the point on the second map corresponding to the position of the facility. Furthermore, in this case, the map display means may display the second map in the following form. The graphic displayed at the position on the first map whose specification is accepted by the position specification accepting means may represent the facility disposed at the point on the first map corresponding to the position whose specification is accepted by the position specification accepting means, and the same facility as the facility represented by the graphic on the first map displayed at the position whose specification is accepted by the position specification accepting means may be displayed and emphasized with a graphic on the second map.

This allows the user to identify the positions on both maps corresponding to the facility of interest on the first map which is the three-dimensional map, and to obtain the information and matter about the facility only by specifying the graphic representing the facility on the first map.

In the above-mentioned navigation apparatus, in a case where the first map is the three-dimensional map and the second map is the two-dimensional map, when the position specification accepting means accepts the specification of the position on the display area with the second map being displayed thereon, the map display means may display the first map in the following form. That is, when the position specification accepting means accepts the specification of the position on the display area with the second map being displayed thereon, a predetermined mark is disposed at a position on the first map representing the same point as the point on the second map corresponding to the position whose specification is accepted by the position specification accepting means. Furthermore, at this time, when the position specification accepting means accepts the specification of the position on the display area with the second map being displayed thereon, the map display means may display the first map in such a form that a facility existing at the point on the second map corresponding to the position whose specification is accepted by the position specification accepting means is displayed and emphasized with a graphic on the first map.

This can provide the user with the point and facility on the first map corresponding to the point on the second map which corresponds to the position whose specification is accepted by the position specification accepting means so that the user can identify the point and facility through intuition.

Note that in displaying the first map as mentioned above, in such a form that the facility existing at the point on the second map corresponding to the position whose specification is accepted by the position specification accepting means is displayed and emphasized with the graphic represented on the first map, the map display means may preferably display the first map as follows. That is, in order to ensure good visibility of the emphasized graphic, the first map may be displayed by at least partially rendering a graphic representing another facility on the first map transparent, the graphic of another facility being positioned to at least partially cover the graphic for representing one facility on the first map, this one facility being also disposed at the position on the second map corresponding to the position whose specification is accepted by the position specification accepting means.

The arrangement of each navigation apparatus described above can be applied likewise to any other map display device for simultaneously displaying the first map and the second map which differs from the first map in representation form, thereby obtaining the same effect. In this case, the map display device may not include current position calculation means and current position display means.

As mentioned above, the invention allows the user to easily identify the position of a point on the other map corresponding to a point on one map when a plurality of different types of maps are simultaneously displayed. Furthermore, in the invention, when the plurality of different types of maps are displayed simultaneously, more information about the user-specified point on the map can be provided to the user without degrading visibility.

### BRIEF DESCRIPTION OF THE DRAWINGS

FIG. 1 is a block diagram showing a configuration of a navigation apparatus according to one preferred embodiment of the invention;

FIG. 2 is a diagram showing map data stored in the navigation apparatus of the embodiment;

FIG. 3 is a diagram showing an example of a display screen included in the navigation apparatus of the embodiment;

FIG. 4 is a flowchart of selected point information presentation processing according to the embodiment;

FIG. 5 is a diagram showing an example of another display screen of the navigation apparatus according to another embodiment;

FIG. 6 is a diagram showing an example of another display screen of the navigation apparatus according to another embodiment;

FIG. 7 is a diagram showing an example of another display screen of the navigation apparatus according to another embodiment; and

FIG. 8 is a diagram showing an example of another display screen of the navigation apparatus according to another embodiment.

### DETAILED DESCRIPTION OF THE PREFERRED EMBODIMENTS

Reference will now be made to preferred embodiments of the invention which are illustrated in the accompanying drawings.

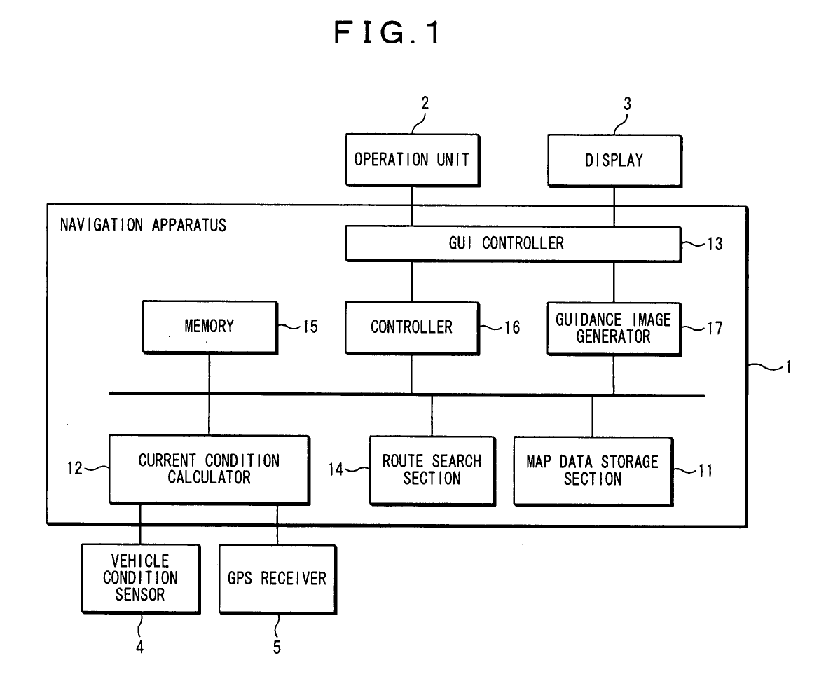

Referring to FIG. 1, a navigation system (which means the entire navigation structure according to the invention) according to one preferred embodiment of the invention includes a navigation apparatus (specifically, a navigation unit included in the navigation structure of the invention) 1, an operation unit 2, a display 3, a vehicle condition sensor 4, and a GPS receiver 5. The vehicle condition sensor 4 is composed of a group of sensors for detecting conditions of a vehicle, including an azimuth sensor, such as an angular acceleration sensor, or a magnetic field sensor, and a vehicle speed sensor, such as a vehicle speed pulse sensor. The display 3 may include, for example, a liquid crystal display. The operation unit 2 may include, for example, a touch panel superimposed on a display surface of the display 3, or a remote controller disposed separately from the display 3.

The navigation apparatus 1 includes a map data storage section 11 serving as a storage device for storing therein map data representing maps, such as a DVD drive or a HDD, a current condition calculator 12, a GUI controller 13 for providing the user with a GUI using the operation unit 2 and the display 3, a route search section 14, a memory 15, a controller 16, and a guidance image generator 17.

It should be noted that the hardware of the above-mentioned navigation apparatus 1 may be a CPU circuit/computer including a general configuration of a peripheral device, such as a microprocessor, a memory, or any other graphic processor or geometric processor, and the like. In this case, each function and processing of each component of the navigation apparatus 1 as described below may be embodied by executing a previously prepared program with the microprocessor. Also, in this case, such a program may be provided to the navigation apparatus 1 via a recording medium or an appropriate communication path.

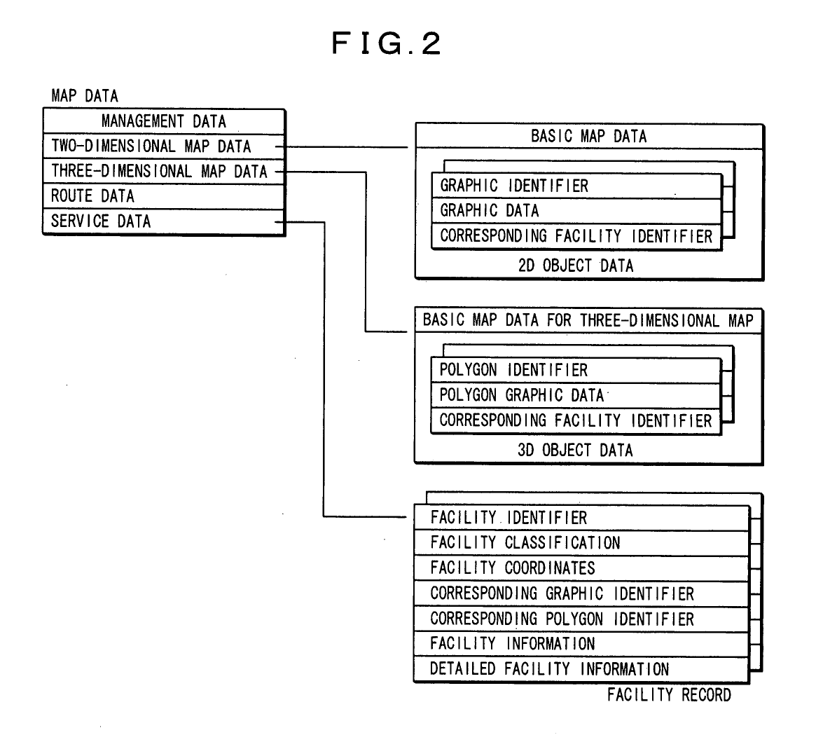

FIG. 2 shows the contents of the map data stored in the map data storage section 11. As shown in the figure, the map data includes management data containing the manufacturing date and time of the map data, two-dimensional map data representing a two-dimensional map, three-dimensional map data representing a three-dimensional map, route data indicative of information about route classification and route names of each route, such as a national highway or a prefectural highway, and service data.

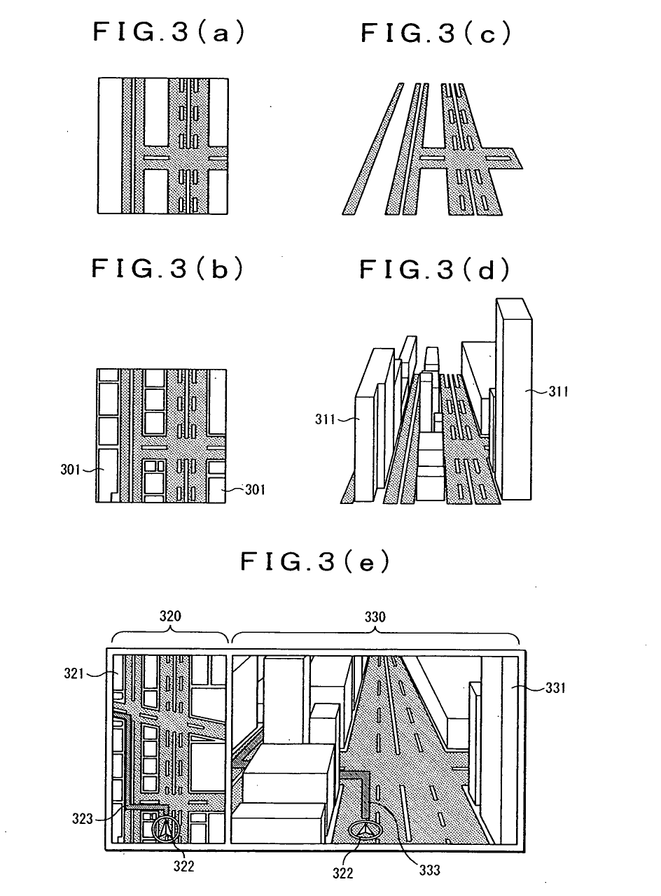

The two-dimensional map data includes basic map data and a plurality of pieces of 2D object data. The basic map data is data representing a basic road map as shown in FIG. 3(a), and each 2D object data is data about a two-dimensional graphic which represents a facility, such as a house or a building, on the two-dimensional map. As shown in FIG. 3(b), the two-dimensional graphic 301 represented by each 2D object data is combined with the road map represented by the basic map data shown in FIG. 3(a) to constitute the two-dimensional map. Each 2D object data described herein includes a graphic identifier serving as an identifier of the 2D object data, graphic data for definition of the position and shape of the two-dimensional graphic 301 indicative of the facility, such as the house or building, and a corresponding facility identifier. Note that the corresponding facility identifier included in the 2D object data will be described later.

The three-dimensional map data includes basic map data for the three-dimensional map and a plurality of pieces of 3D object data. The basic map data for the three-dimensional map is data representing basic road maps shown in FIG. 3(c) in a three-dimensional manner, and each 3D object data is data of a three-dimensional graphic representing the facility, such as the house or building, on the three-dimensional map. As shown in FIG. 3(d), a three-dimensional graphic 311 represented by each 3D object data is combined with a three-dimensional road map represented by basic map data for a three-dimensional map shown in FIG. 3(c) to constitute the three-dimensional map. Each 3D object data described herein includes a polygon identifier serving as an identifier for the 3D object data, polygon data for definition of the position and shape of the three-dimensional graphic 311 representing the facility, such as the housing or building, and a corresponding facility identifier. Note that the corresponding facility identifier included in the 3D object data will also be described later.

The service data contains a facility record corresponding to each facility, such as the house or building. Each facility record contains the facility identifier serving as the identifier for the corresponding facility, a facility classification for representing the type of the corresponding facility, such as a building or a theater, facility coordinates representing the position of the corresponding facility, a corresponding graphic identifier representing a graphic identifier for a two-dimensional graphic of the 2D object data, which represents the corresponding facility on the two-dimensional map, a corresponding polygon identifier representing a polygon identifier for a three-dimensional graphic of the 3D object data, which represents the corresponding facility on the three-dimensional map, facility information including basic information about the corresponding facility, such as a facility name, and detailed facility information about the corresponding facility for use of the facility.

The corresponding facility identifier included in the 2D object data represents a facility identifier of the facility record corresponding to the facility indicated by the two-dimensional graphic represented by the 2D object data. Likewise, the corresponding facility identifier included in the 3D object data represents a facility identifier of the facility record corresponding to the facility indicated by the three-dimensional graphic represented by the 3D object data.

The current condition calculator 12 of the navigation apparatus 1 with this construction will repeat the following processes. That is, the current condition calculator 12 performs map matching processing for matching a current position of the vehicle estimated from outputs of the vehicle condition sensor 4 and the GPS receiver 5 with the two-dimensional map represented by the two-dimensional data read from the map data storage section 11, and then determines the most probable current coordinates of the vehicle and the most probable current traveling direction thereof as a current position and a current traveling direction to set the determined position and direction in the memory 15.

The controller 16 accepts the setting of a destination via the operation unit 2 and the GUI controller 13 in response to a request for setting the destination from the user to set the destination in the memory 15. Then, in accepting the setting of the destination, the controller 16 causes the route searching section 14 to search for a recommended route to the destination set in the memory 15. The route search section 14 calculates the minimum cost route from the current position to the destination stored in the memory as the recommended route based on a predetermined cost model, such as a minimum distance, referring to the two-dimensional map represented by the two-dimensional map data read from the map data storage section 11. Then, the route search section 14 sets the route data of the recommended route calculated in the memory 15. When the current position set in the memory 15 is approaching the destination, the controller 16 determines that the vehicle is going to reach the destination, and clears the recommended route set in the memory 15.

The controller 16 repeats guidance image generating processing as follows. That is, the controller 16 sets a two-dimensional map display sub-screen 320 and a three-dimensional map display sub-screen 330 on a display screen of the display 3 via the GUI controller 13 as shown in FIG. 3(e). Thus, the controller 16 causes the guidance image generator 17 to display the two-dimensional map on the two-dimensional map display sub-screen 320 as well as the three-dimensional map on the three-dimensional map display sub-screen 330.

More specifically, the guidance image generator 17 displays on the two-dimensional map display sub-screen 320 a two-dimensional map image 321 indicative of the two-dimensional map covering the current position and its surroundings represented by the two-dimensional map data read from the map data storage section 11 at a reduction scale according to the user's pre-setting or the initial setting with the current traveling direction set in the memory 15 being oriented upward. Furthermore, at this time, the guidance image generator 17 displays a current position mark 322 at a position corresponding to the current position set in the memory 15 on the two-dimensional map image 321 displayed on the two-dimensional map display sub-screen 320. When route data about the recommended route is set in the memory 15, the guidance image generator 17 displays a recommended route graphic 323 representing a part of the recommended route from the current position toward the destination on the two-dimensional map image 321. Note that when the destination is included in a geographic range represented by the two-dimensional map image 321, the guidance image generator 17 also displays a destination mark indicative of the position of the destination on the two-dimensional map image 321.

On the other hand, the guidance image generator 17 generates and displays a three-dimensional map image 331 representing a three-dimensional map covering the current position and its surroundings on the three-dimensional map display sub-screen 330 based on the three-dimensional map data read from the map data storage section 11. The three-dimensional map image 331 is generated as an image obtained by observation of the three-dimensional map represented by the three-dimensional map data in a line of sight looking down at the current traveling direction set in the memory 15 from a view point to the rear of the current position from the air at a viewing angle according to the user's pre-setting or the initial setting. Furthermore, at this time, the guidance image generator 17 displays a current position mark 332 at a position corresponding to the current position set in the memory 15 on the three-dimensional map image 331 displayed on the three-dimensional map display sub-screen 330. When route data about the recommended route is set in the memory 15, the guidance image generator 17 displays a recommended route graphic 333 representing a part of the recommended route from the current position toward the destination on the three-dimensional map image 331. Note that when the destination is included in a geographic range represented by the three-dimensional map image 331, the guidance image generator 17 also displays a destination mark indicative of the position of the destination on the three-dimensional map image 331.

With the above-mentioned arrangement, the controller 16 performs selected-point information presentation processing.

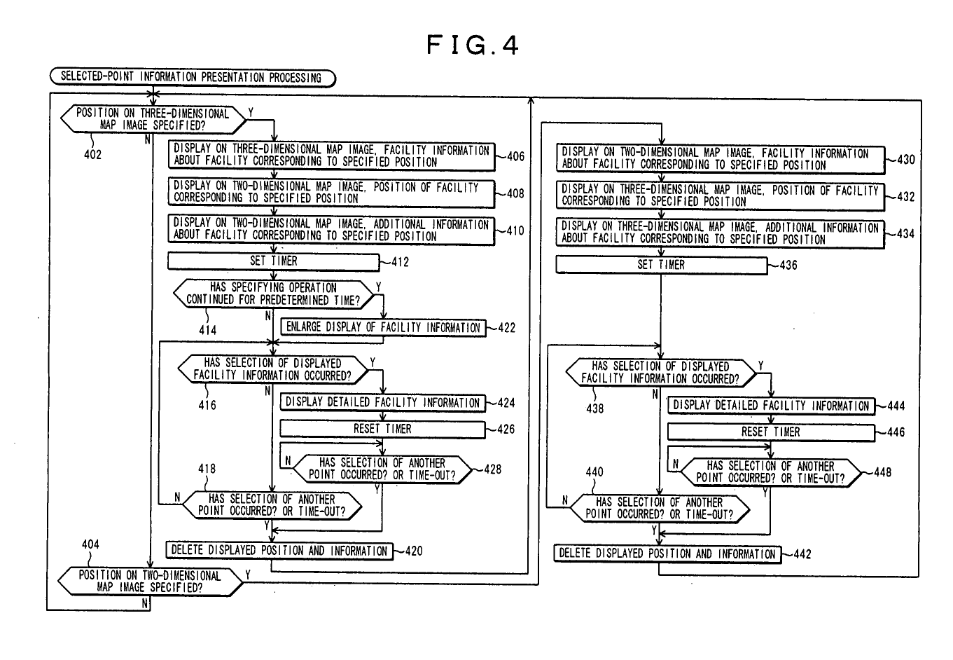

FIG. 4 illustrates steps of the selected-point information presentation processing. As shown in the flowchart, in this processing, the controller 16 monitors the occurrence of a user's specification of a position on the three-dimensional map image 331 (step S402), and the occurrence of a user's specification of a position on the two-dimensional map image 321 (step S404).

For the user's specification of the position on a map image, a cursor movable by the user is displayed on the display screen of the display 3. When the cursor is positioned on the two-dimensional map image for the specification, it is determined that a position on the two-dimensional map image 321 corresponding to the position of the cursor is accepted as a specified position. In contrast, when the cursor is positioned on the three-dimensional map image 331 for the specification, it is determined that a position on the three-dimensional map image 331 corresponding to the position of the cursor is accepted as the specified position. Alternatively, in the case where the operation unit 2 uses a touch panel, when the position touched by the user is located on the two-dimensional map image 321, it may be determined that a position on the two-dimensional map image 321 corresponding to the position touched on the two-dimensional map image 321 is accepted as the specified position. In contrast, when the position touched by the user is located on the three-dimensional map image 331, it may be determined that a position on the three-dimensional map image 331 corresponding to the position touched on the three-dimensional map image 331 is accepted as the specified position.

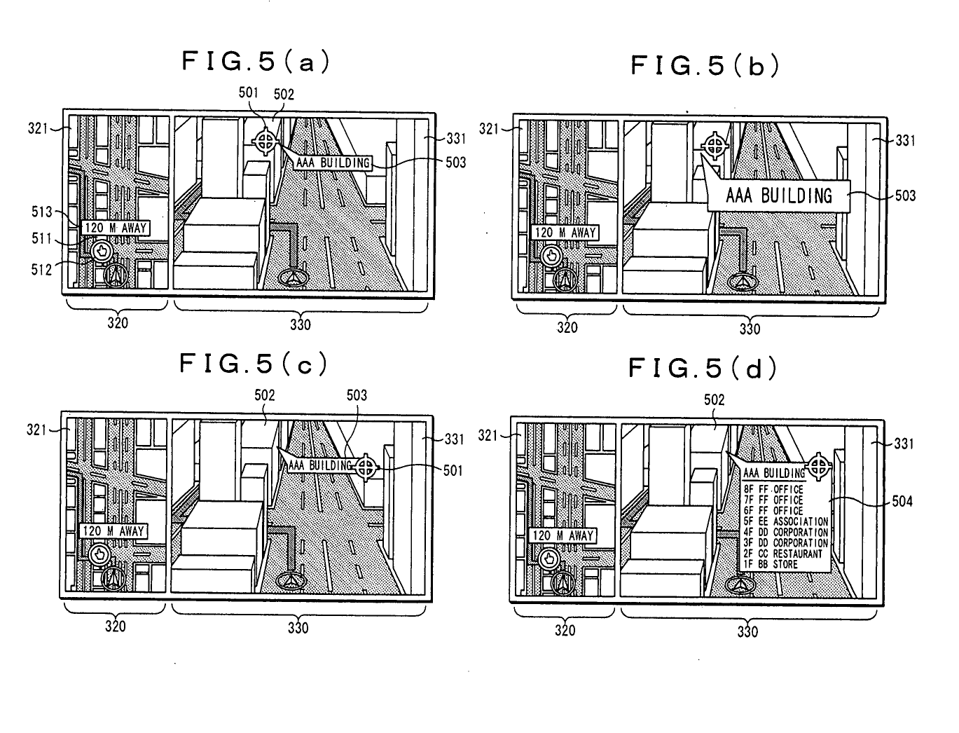

When the point is specified on the three-dimensional map image 331 by the user (step S402), first facility information about a facility corresponding to the specified position is displayed on the three-dimensional map image 331 (step S406). The facility corresponding to the specified position means a facility represented with a three-dimensional graphic displayed at the specified position on the three-dimensional map image 331. Furthermore, the facility information about the facility corresponding to the position specified is facility information registered in a facility record of the facility. More specifically, the facility information is obtained as facility information registered in the facility record represented by the corresponding facility identifier of the three-dimensional object data of the three-dimensional graphic which is displayed at the specified position on the three-dimensional map image 331. It should be noted that this facility information is displayed near the three-dimensional graphic displayed at the specified position on the three-dimensional map image 331. For example, as shown in FIG. 5(a), when the position on the three-dimensional map image 331 is designated by the user with the cursor 501, facility information (in the figure, a facility name “AAA building”) 503 of the three-dimensional graphic 502 which corresponds to a building displayed at the position of the cursor is displayed near the three-dimensional graphic 502 in the form of a balloon leading from the three-dimensional graphic 502.

Then, a position of the facility on the two-dimensional map image 321 corresponding to the specified position is displayed on the two-dimensional map image 321 (step S408). For example, as shown in FIG. 5(a), the same facility as the facility represented by the three-dimensional graphic 502 corresponding to the specified position is displayed with a two-dimensional graphic 511 on the two-dimensional map image 321 in a highlighted color. Alternatively or additionally, a mark 512 may be displayed for representing, on the two-dimensional map image 321, the corresponding position of the facility represented by the three-dimensional graphic 502 corresponding to the specified position (or the position of the two-dimensional graphic 511 which represents the same facility as that of the three-dimensional graphic 502). The two-dimensional graphic 511 on the two-dimensional map image 321 representing the same facility as that represented by the three-dimensional graphic 502 corresponding to the specified position is obtained as the two-dimensional graphic 511 represented by the two-dimensional object data including the same graphic identifier as the corresponding graphic identifier of the facility record for storing therein the facility information displayed at the step 406.

Furthermore, additional information regarding the facility represented by the three-dimensional graphic 502 corresponding to the specified position is displayed near the position of the facility on the two-dimensional map image 321 which corresponds to the facility represented by the three-dimensional graphic 502 corresponding to the specified position (or near the position of the two-dimensional graphic 511 representing the same facility as that represented by the three-dimensional graphic 502) (step S410). For example, as shown in FIG. 5(a), information about the facility is displayed as additional information 513 near the position of the facility on the two-dimensional map image 321 corresponding to the facility represented by the three-dimensional graphic 502 at the specified position. In the example shown, the additional information includes a distance to the facility from the current position set in the memory 15.

Then, the timer is set for a predetermined time-out time (for example, 5 seconds) (step S412). It is monitored whether or not the user's specifying operation of the position has continued for a predetermined time (for example, 0.5 seconds) or more (step S414).

If the user's position specifying operation has continued for the predetermined time or more (step S414), the display of the facility information 503 displayed on the three-dimensional map image 331 is enlarged (step S422) as shown in FIG. 5(b), for example, and then the operation proceeds to step S416. In contrast, if the user's position specifying operation is ended before the predetermined time expires, the operation proceeds to step S416 as it is. For example, in a case where the position specifying operation is accepted by a button of the operation unit 2 being pushed down, the continuation of the user's position specifying operation for the predetermined time or more is detected when the button of the operation unit 2 continues to be held down for the predetermined time or more. Alternatively, in a case where the position specifying operation is accepted by the user's touching of the touch panel, the continuation of the position specifying operation may be detected when the touch panel continues to be touched for the predetermined time or more.

When the operation proceeds to step S416, it is monitored whether or not the facility information displayed on the three-dimensional map image 331 is specified by the user (step S416), and then whether or not another new position is specified by the user, or whether or not the time-out set by the timer is reached (step S418).

When the facility information displayed on the three-dimensional map image 331 is specified by the user (step S416), detailed facility information about the facility represented by a three-dimensional graphic corresponding to the specified position is displayed near the three-dimensional graphic (step S424).

For example, when the position designated by the cursor 501 within the display area of the facility information 503 displayed on the three-dimensional map image 331 is specified by the user as shown in FIG. 5(c), detailed facility information 504 stored in a facility record of the facility represented by the three-dimensional graphic 502 is displayed near the three-dimensional graphic 502 in the form of a balloon leading from the three-dimensional graphic 502 as shown in FIG. 5(d). Note that in the example shown, this detailed facility information represents a tenant of each floor of the building represented by the three-dimensional graphic 502. The facility record for storing therein the detailed facility information to be displayed is obtained as the same facility record as that for storing therein the facility information displayed at the step S406.

Then, after displaying such detailed facility information, the timer set at step S412 is reset (step S426). After waiting until the time-out of the timer is reached, or until a new position has been specified by the user (step S428), the operation proceeds to step S420, and the display of the facility information displayed at step S406, of the position displayed at step S408, of the additional information displayed at step S410, and of the detailed facility information displayed at step S424 are deleted. Thereafter, the operation returns to the monitoring steps S402 to S404. When the occurrence of the specification of a new position by the user is detected at step S428, the user's position specification detected at step S428 is sensed at step S402 or S404 directly after step S428.

In contrast, when the occurrence of the specification of a new position by the user or the occurrence of the time-out of the timer is detected at step S418, the display of the facility information displayed at step S406, of the position displayed at step S408, and of the additional information displayed at step S410 are deleted. Thereafter, the operation also returns to the monitoring steps S402 to S404. When the occurrence of the specification of a new position by the user is detected at step S418, the user's position specification detected at step S418 is also sensed at step S402 or S404 directly after step S418.

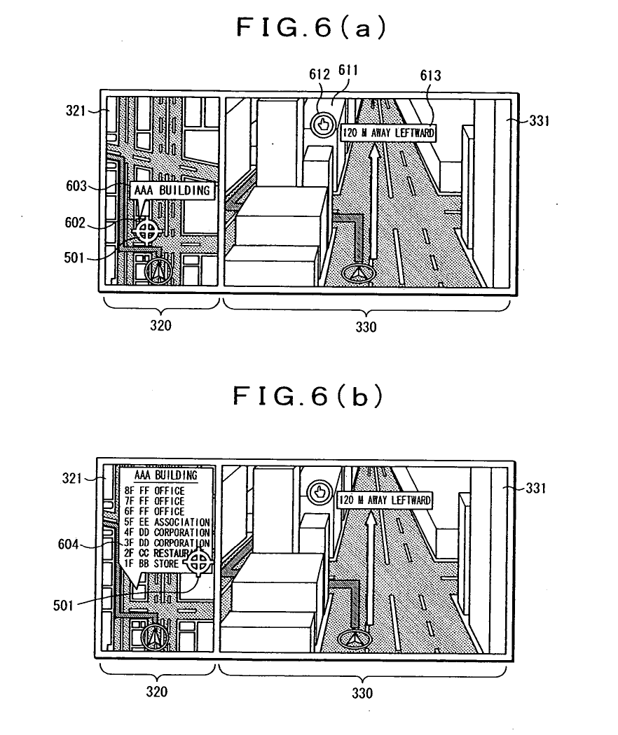

When the occurrence of the specification of a point on the two-dimensional map image 321 by the user is detected at step S404, first facility information about a facility corresponding to the specified position is displayed on the two-dimensional map image 321 (step S430). The facility corresponding to the specified position means a facility represented by a two-dimensional graphic displayed at the specified position on the two-dimensional map image 321. Furthermore, the facility information about the facility corresponding to the specified position is facility information registered in a facility record of the facility. More specifically, the facility information is obtained as facility information registered in the facility record represented by the corresponding facility identifier of the two-dimensional object data of the two-dimensional graphic which is displayed at the specified position on the two-dimensional map image 321. It should be noted that this facility information is displayed near the two-dimensional graphic displayed at the specified position on the two-dimensional map image 321. For example, as shown in FIG. 6(a), when the position on the two-dimensional map image 321 is designated by the user with the cursor 501, facility information (in the figure, a facility name “AAA building”) 603 of the two-dimensional graphic 602 which corresponds to a building displayed at the position of the cursor 501 is displayed near the two-dimensional graphic 602 in the form of a balloon leading from the two-dimensional graphic 602.

Then, a position on the three-dimensional map image 331 corresponding to the specified position is displayed on the three-dimensional map image 331 (step S432). For example, as shown in FIG. 6(a), the same facility as the facility represented by the two-dimensional graphic 602 corresponding to the specified position is displayed with a three-dimensional graphic 611 on the three-dimensional map image 331, in a highlighted color. Alternatively or additionally, a mark 612 may be displayed on the three-dimensional map image 331 at the position of the facility represented by the two-dimensional graphic 602 corresponding to the specified position (or at the position of the three-dimensional graphic 611 representing the same facility as that of the two-dimensional graphic 602). The three-dimensional graphic 611 on the three-dimensional map image 331 representing the same facility as that represented by the two-dimensional graphic 602 corresponding to the specified position is obtained as the three-dimensional graphic 611 represented by the three-dimensional object data including the same polygon identifier as the corresponding polygon identifier of the facility record for storing therein the facility information displayed at step S430.

Furthermore, additional information regarding the facility corresponding to the specified position is displayed near the position of the facility on the three-dimensional map image 331 represented by the two-dimensional graphic 602 corresponding to the specified position (step S434). For example, as shown in FIG. 6(a), information about the facility is displayed as additional information 613 near the position of the facility on the three-dimensional map image 331 which corresponds to the facility represented by the two-dimensional graphic 602 corresponding to the specified position (or at the position of the three-dimensional graphic 611 representing the same facility as that represented by the two-dimensional graphic 602). In the example shown, the additional information includes the distance to the facility from the current position set in the memory 15.

Then, the timer is set for a predetermined time-out time (for example, 5 seconds) (step S436). It is monitored whether or not the facility information displayed on the two-dimensional map image 321 is specified by the user (step S438), and then whether or not another new position is specified by the user, or whether or not the time-out set by the timer is reached (step S440).

When the facility information displayed on the two-dimensional map image 321 is specified by the user (step S438), detailed facility information about the facility represented by a two-dimensional graphic corresponding to the specified position is displayed near the two-dimensional graphic (step S444). For example, when the position is specified by the user within the display area for the facility information 603 displayed on the two-dimensional map image 321 shown in FIG. 6(a), detailed facility information 604 stored in the facility record of the facility represented by the two-dimensional graphic 602 is displayed near the two-dimensional graphic 602 in the form of a balloon leading from the two-dimensional graphic 602 as shown in FIG. 6(b). Note that in the example shown, this detailed facility information represents a tenant of each floor of the building represented by the two-dimensional graphic 602. The facility record for storing therein the detailed facility information to be displayed is obtained as the same facility record as that for storing therein the facility information displayed at the step S430.

Then, after displaying such detailed facility information, the timer set at step S436 is reset (step S446). After waiting until the time-out of the timer is reached, or until a new position has been specified by the user (step S448), the operation proceeds to step S442, and the display of the facility information displayed at step S430, of the position displayed at step S432, of the additional information displayed at step S434, and of the detailed facility information displayed at step S444 are deleted. Thereafter, the operation returns to the monitoring steps S402 to S404. When the occurrence of the specification of a new position by the user is detected at step S448, the user's position specification detected at step S448 is sensed at step S402 or S404 directly after step S448.

In contrast, when the occurrence of the specification of a new position by the user or the occurrence of the time-out of the timer is detected at step S440, the display of the facility information displayed at step S430, of the position displayed at step S432, and of the additional information displayed at step S434 are deleted. Thereafter, the operation also returns to the monitoring steps S402 to S404. When the occurrence of the specification of a new position by the user is detected at step S440, the user's position specification detected at step S440 is sensed at step S402 or S404 directly after step S440.

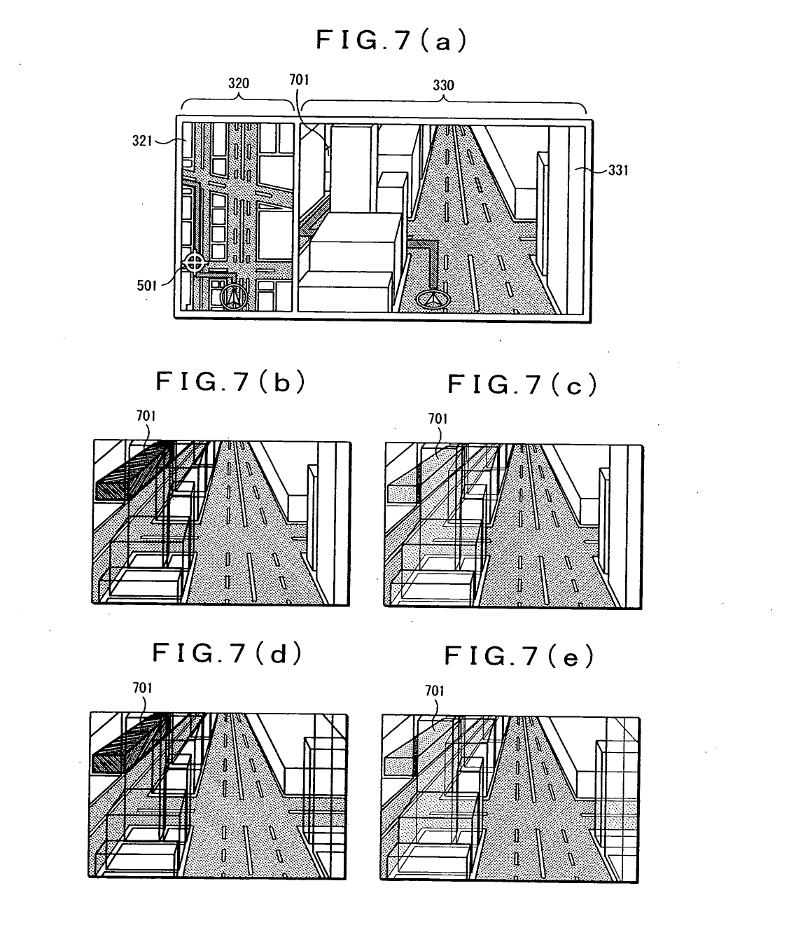

In the above-described selected-point information presentation processing, as shown in FIG. 7(a), a three-dimensional graphic 701 represents on the three-dimensional map image 331 the facility corresponding to the position represented by the cursor 501 on the two-dimensional map image 321, the specification of the position being accepted at step S404, and the three-dimensional graphic 701 may be invisible in some cases because it is positioned behind another three-dimensional graphic on the three-dimensional map image 331.

In such a case, the three-dimensional map image 331 is generated such that a three-dimensional graphic positioned in front of the three-dimensional graphic 701 is displayed in the form of a wire frame as shown in FIG. 7(b), or such that a three-dimensional graphic positioned in front of the three-dimensional graphic 701 is displayed in a translucent manner as shown in FIG. 7(c). This enables the user to clearly and visually identify a route (road) from the current position set in the memory 15 to the point represented by the three-dimensional graphic 701. Alternatively, in such a case, the three-dimensional map image 331 may be generated such that all three-dimensional graphics other than the three-dimensional graphic 701 are displayed in the three-dimensional map image 331 in the form of wire frames as shown in FIG. 7(d), or such that a three-dimensional graphic other than the three-dimensional graphic 701 is displayed in a translucent form as shown in FIG. 7(e). This may also enable the user to clearly and visually identify the route (road) from the current position set in the memory 15 to the point represented by the three-dimensional graphic 701.

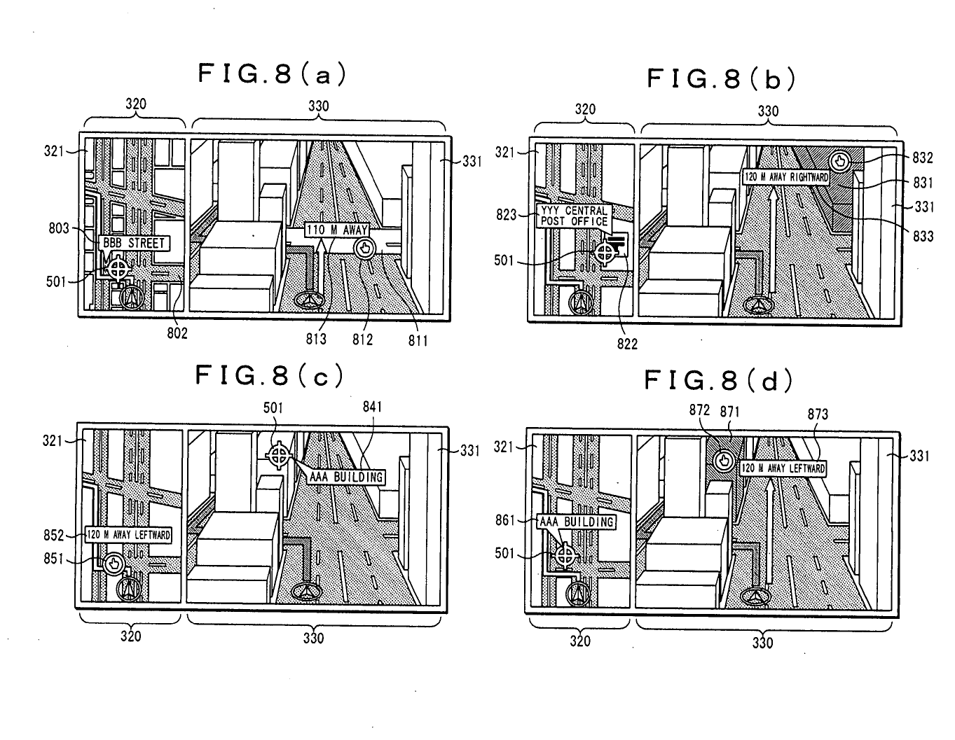

In the described embodiments, the map data may include two-dimensional object data of a two-dimensional graphic representing a road on a two-dimensional map, and three-dimensional object data of a three-dimensional graphic representing a road on a three-dimensional map. With this arrangement, for example, as shown in FIG. 8(a), when a road 802 is specified or designated on the two-dimensional map image 321 by the cursor 501, facility information 803 including a name of the specified road and the like is displayed near the road specified on the two-dimensional map image 321. In addition, in the three-dimensional map image 331, a three-dimensional graphic 811 representing the specified road is displayed and emphasized, a mark 812 representing the position of the specified road is displayed, and additional information 813 representing the distance to the road is displayed.

In the embodiments described above, the two-dimensional graphic object data included in the map data may be to display an icon graphic indicative of a facility as a two-dimensional graphic, or to define a character string representing the facility information, such as the facility classification or the facility name on the two-dimensional map image 321. With this arrangement, for example, in a case where the two-dimensional graphic object data is to display the icon graphic representing the facility as the two-dimensional graphic, when an icon 822 at the position represented by the cursor 501 on the two-dimensional image map 321 is specified or designated as shown in FIG. 8(b), the facility name or the like represented by the icon 822 specified as the facility information 823 is displayed near the icon 822 specified on the two-dimensional map image 321. In addition, in the three-dimensional map image 331, a three-dimensional graphic 831 representing the facility designated by the specified icon is displayed and emphasized, a mark 832 indicative of the position of the facility is displayed, and additional information 833 indicative of the distance to the facility is displayed. Note that in a case where the two-dimensional graphic object data included in the map data is to define a character string representing the facility on the two-dimensional map image 321, when the character string is specified or designated by the cursor on the two-dimensional map image 321, the facility information about the facility represented by the specified character string is displayed near the specified character string on the two-dimensional map image 321. In addition, in the three-dimensional map image 331, a three-dimensional graphic representing the facility designated by the specified character string is displayed and emphasized, the mark indicative of the position of the facility is displayed, and additional information of the facility is displayed.

In the above-mentioned embodiments, the map data may omit the two-dimensional graphic object data. In this case, in the selected-point information presentation processing performed by the controller 16, when the specification of the position on the three-dimensional map image 331 indicated by the cursor 501 is accepted as shown in FIG. 8(c) at step S402, the facility information 841 is displayed on the three-dimensional map image 331 at step S406. Thereafter, at step S408, a mark 851 is displayed at the position on the two-dimensional map image 321 corresponding to the coordinates of the facility in the facility record, the facility information of which is displayed at step S406, whereby the position of the facility on the two-dimensional map image 321 corresponding to the specified position is displayed on the two-dimensional map image 321. At step S410, the detailed facility information 852 is displayed near the position of the mark 851.

Moreover, in this case, when the specification of the position represented by the cursor 501 on the two-dimensional map image 321 is accepted at step S404 as shown in FIG. 8(d), a facility record having facility coordinates which are positioned near the position specified on the two-dimensional map image 321 is searched for at step S430, and facility information 861 stored in the facility record searched for is displayed near the position specified on the two-dimensional map image 321. At step S432, the three-dimensional graphic 871 of the three-dimensional object data including the same polygon identifier as the corresponding polygon identifier of the facility record, the facility information of which is displayed at step S430, is displayed in a highlighted color on the three-dimensional map image 331, and the mark 872 is displayed at the position of the three-dimensional graphic 871 on the three-dimensional map image 331. At step S434, the additional information 873 regarding the facility represented by the three-dimensional graphic 871 is displayed near the position of the three-dimensional graphic 871.

As mentioned above, according to one embodiment, the two-dimensional map image 321 and the three-dimensional map image 331 can be displayed simultaneously, and the position of the point on the other map image corresponding to the position specified on one map image can be displayed. This enables the user to easily identify through intuition the position on the other map image corresponding to the point of interest specified on the one map image. In the embodiment, information regarding the point corresponding to the position specified on the one map image is displayed near the position of the facility on the other map image as additional information as well as near the point on the one map as the facility information. Therefore, the navigation apparatus of the embodiment can provide the user with much information and matter regarding the point specified by the user so that the user can identify the information and matter in relation to the user-specified point without degrading visibility, as compared to a case where matter and information regarding the point specified by the user is displayed only on one map image.

It should be noted that although the above-mentioned embodiments are applied to a navigation apparatus by way of example in the above description, the technique of the map display and facility information presentation as described above can likewise be applied to any device for simultaneously displaying a plurality of different types of maps, other than a navigation apparatus. Moreover, the above-mentioned technique of the map display and facility information presentation can likewise be applied to a case where map images of two maps having different representation forms, which are other than the above-mentioned two-dimensional map image and three-dimensional map image in combination, are simultaneously displayed in combination with each other, as well as to a case where three or more map images having different representation forms are displayed simultaneously. For example, the map image simultaneously displayed may include a map image representing a bird's-eye view of the two-dimensional map.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A vehicle navigation apparatus for simultaneously displaying a first map and a second map which differs from the first map in representation form, said navigation apparatus comprising:
a display;
map display means for displaying said first map and said second map at different display areas of said display;
current position calculation means for calculating a current position of the vehicle;
current position display means for displaying a current position mark indicative of the current position calculated by said current position calculation means on at least one of the first map and the second map displayed by said map display means; and
position specification accepting means adapted to accept a specification of a position in the display area with the first map being displayed thereon from a user,
wherein said map display means is adapted to display the second map in such a form that a position on the second map representing the same point as a point on the first map is identifiable, the point on the first map corresponding to the position whose specification is accepted by said position specification accepting means.

2. The navigation apparatus according to claim 1, wherein said position specification accepting means accepts from the user the specification of the position in one of the display area with the first map being displayed thereon and the display area with the second map being displayed thereon, and
wherein, when said position specification accepting means accepts the specification of the position in the display area with the second map being displayed thereon, said map display means is adapted to display the first map in such a form that the position on the first map representing the same point as the point on the second map is identifiable, the point on the second map corresponding to the position whose specification is accepted.

3. The navigation apparatus according to claim 2, wherein said first map is a three-dimensional map, and said second map is a two-dimensional map, and
wherein, when said position specification accepting means accepts the specification of the position in the display area with the second map being displayed thereon, said map display means is adapted to display the first map in such a form that a predetermined mark is disposed at the position on the first map representing the same point as the point on the second map, the point on the second map corresponding to the position whose specification is accepted by said position specification accepting means.

4. The navigation apparatus according to claim 2, wherein said first map is a three-dimensional map, and said second map is a two-dimensional map, and
wherein, when said position specification accepting means accepts the specification of the position in the display area with the second map being displayed thereon, said map display means is adapted to display the first map in such a form that a facility existing at the point on the second map corresponding to the position whose specification is accepted by said position specification accepting means is displayed and emphasized with a graphic on the first map.

5. The navigation apparatus according to claim 4, wherein, when said position specification accepting means accepts the specification of the position in the display area with the second map being displayed thereon, a first facility exists at the point on the second map corresponding to the position whose specification is accepted by said position specification accepting means, and said map display means is adapted to display the first map by at least partially rendering a graphic representing another facility on the first map transparent, the graphic of said another facility being positioned to at least partially overlap a graphic for representing said first facility on the first map.

6. The navigation apparatus according to claim 1, further comprising point information display means for displaying information about the point on the first map corresponding to the position whose specification is accepted by said position specification accepting means, near the point on the first map within the display area with the first map being displayed thereon.

7. The navigation apparatus according to claim 6, wherein said position specification accepting means accepts from the user the specification of the position in one of the display area with the first map being displayed thereon and the display area with the second map being displayed thereon, and
wherein, when said position specification accepting means accepts the specification of the position in the display area with the second map being displayed thereon, said map display means is adapted to display the first map in such a form that the position on the first map representing the same point as the point on the second map is identifiable, the point on the second map corresponding to the position whose specification is accepted, and
wherein, when said position specification accepting means accepts the specification of the position in the display area with the second map being displayed thereon, said point information display means is adapted to display information about the point on the second map corresponding to the position whose specification is accepted by said position specification accepting means, near the point on the second map within the display area with the second map being displayed thereon.

8. The navigation apparatus according to claim 6, wherein said point information display means is adapted to display matter associated with the point on the first map corresponding to the position whose specification is accepted by said position specification accepting means, near the position on the second map representing the same point as the point on the first map corresponding to the position whose specification is accepted by said position specification accepting means, within the display area with the second map being displayed thereon.

9. The navigation apparatus according to claim 8,
wherein said position specification accepting means accepts from the user the specification of the position at one of the display area with the first map being displayed thereon and the display area with the second map being displayed thereon , and
wherein, when said position specification accepting means accepts the specification of the position in the display area with the second map being displayed thereon, said map display means is adapted to display the first map in such a form that the position on the first map representing the same point as the point on the second map is identifiable, the point on the second map corresponding to the position whose specification is accepted, and
wherein, when said position specification accepting means accepts the specification of the position in the display area with the second map being displayed thereon, said point information display means is adapted to display information regarding the point on the second map corresponding to the position whose specification is accepted by said position specification accepting means, near the point on the second map within the display area with the second map being displayed thereon, while said point information display means is adapted to display matter associated with the point on the second map corresponding to the position whose specification is accepted by said position specification accepting means, near the position on the first map representing the same point as the point on the second map corresponding to the position whose specification is accepted by said position specification accepting means, within the display area with the first map being displayed thereon.

10. The navigation apparatus according to claim 1, wherein said first map is a three-dimensional map, and said second map is a two-dimensional map, and
wherein said map display means is adapted to display the second map in such a form that a predetermined mark is disposed at the position on the second map representing the same point as the point on the first map which corresponds to the position whose specification is accepted by said position specification accepting means.

11. The navigation apparatus according to claim 1, wherein said first map is a three-dimensional map, and said second map is a two-dimensional map, and
wherein said map display means is adapted to display the second map in such a form that a facility existing at the point on the first map corresponding to the position whose specification is accepted by said position specification accepting means is displayed and emphasized with a graphic on the second map.

12. The navigation apparatus according to claim 1, wherein said first map is a three-dimensional map, and said second map is a two-dimensional map, and
wherein said map display means is adapted to display the second map in such a form that a graphic displayed at the position on the first map whose specification is accepted by the position specification accepting means represents a facility disposed at the point on the first map corresponding to the position whose specification is accepted by said position specification accepting means, and that a predetermined mark is disposed at a point on the second map corresponding to the position of the facility.

13. The navigation apparatus according to claim 1, wherein said first map is a three-dimensional map, and said second map is a two-dimensional map, and
wherein said map display means is adapted to display the second map in such a form that a graphic displayed at the position on the first map whose specification is accepted by said position specification accepting means represents a facility disposed at the point on the first map corresponding to the position whose specification is accepted by said position specification accepting means, and that the same facility as the facility represented by the graphic on the first map displayed at the position whose specification is accepted by the position specification accepting means is displayed and emphasized with a graphic on the second map.

14. A map display device for simultaneously displaying a first map and a second map which differs from the first map in representation form, said map display device comprising:
a display;
map display means for displaying said first map and said second map at different display areas of said display; and
position specification accepting means adapted to accept a specification of a position in the display area with the first map being displayed thereon from a user,
wherein said map display means is adapted to display the second map in such a form that a position on the second map representing the same point as the point on the first map is identifiable, the point on the first map corresponding to the position whose specification is accepted by said position specification accepting means.

15. The map display device according to claim 14, wherein said position specification accepting means accepts the specification of the position at one of the display area with the first map being displayed thereon and the display area with the second map being displayed thereon from the user, and
wherein, when said position specification accepting means accepts the specification of the position in the display area with the second map being displayed thereon, said map display means is adapted to display the first map in such a form that the position on the first map representing the same point as the point on the second map is identifiable, the point on the second map corresponding to the position whose specification is accepted.

16. The map display device according to claim 14, further comprising point information display means for displaying information about the point on the first map corresponding to the position whose specification is accepted by said position specification accepting means, near the point on the first map within the display area with the first map being displayed thereon.

17. The map display device according to claim 16, wherein said position specification accepting means accepts from the user the specification of the position at one of the display area with the first map being displayed thereon and the display area with the second map being displayed thereon, and
wherein, when said position specification accepting means accepts the specification of the position at the display area with the second map being displayed thereon, said map display means is adapted to display the first map in such a form that the position on the first map representing the same point as the point on the second map is identifiable, the point on the second map corresponding to the position whose specification is accepted, and wherein, when said position specification accepting means accepts the specification of the position at the display area with the second map being displayed thereon, said point information display means is adapted to display information about the point on the second map corresponding to the position whose specification is accepted by said position specification accepting means, near the point on the second map within the display area with the second map being displayed thereon.

18. The map display device according to claim 16, wherein said point information display means is adapted to display matter associated with the point on the first map corresponding to the position whose specification is accepted by said position specification accepting means, near the position on the second map representing the same point as the point on the first map corresponding to the position whose specification is accepted by said position specification accepting means, within the display area within the second map being displayed thereon.

19. The map display device according to claim 18, wherein said position specification accepting means accepts from the user the specification of the position at one of the display area with the first map being displayed thereon and the display area with the second map being displayed thereon, and
wherein, when said position specification accepting means accepts the specification of the position in the display area with the second map being displayed thereon, said map display means is adapted to display the first map in such a form that the position on the first map representing the same point as the point on the second map is identifiable, the point on the second map corresponding to the position whose specification is accepted, and
wherein, when said position specification accepting means accepts the specification of the position in the display area with the second map being displayed thereon, said point information display means is adapted to display information regarding the point on the second map corresponding to the position whose specification is accepted by said position specification accepting means, near the point on the second map within the display area with the second map being displayed thereon, while said point information display means is adapted to display matter associated with the point on the second map corresponding to the position whose specification is accepted by said position specification accepting means, near the position on the first map representing the same point as the point on the second map corresponding to the position whose specification is accepted by the position specification accepting means, within the display area with the first map being displayed thereon.

20. The map display device according to claim 14, wherein one of the first map and the second map is a three-dimensional map, and the other is a two-dimensional map.

21. A map display control method for controlling the display of a first map and a second map which differs from the first map in representation form in a map display device for displaying the map on a display, said method comprising:
simultaneously displaying said first map and said second map at different display areas of said display;
accepting a specification of a position in the display area with the first map being displayed thereon from a user; and
displaying the second map in such a form that a position on the second map representing the same point as the point on the first map is identifiable, the point on the first map corresponding to the position whose specification is accepted.

22. The map display control method according to claim 21, further comprising:
accepting a specification of the position in the display area with the second map being displayed thereon from the user; and
displaying the first map in such a form that the position on the first map representing the same point as the point on the second map is identifiable, the point on the second map corresponding to said accepted position in the display area with the second map being displayed thereon.

23. The map display control method according to claim 21, wherein one of the first map and the second map is a three-dimensional map, and the other is a two-dimensional map.

24. A computer program adapted to be read and executed by an electronic processor, said computer program causing the electronic processor to execute the steps of:
simultaneously displaying a first map and a second map at different display areas of a display, the second map differing from the first map in representation form;
accepting a specification of a position in the display area with the first map being displayed thereon from a user; and
displaying the second map in such a form that a position on the second map representing the same point as the point on the first map is identifiable, the point on the first map corresponding to the position whose specification is accepted.

25. The computer program according to claim 24, said computer program causing said electronic processor to execute the further steps of:
accepting a specification of a position on the display area with the second map being displayed thereon from the user; and
displaying the first map in such a form that the position on the first map representing the same point as the point on the second map is identifiable, the point on the second map corresponding to said accepted position in the display area with the second map being displayed thereon.

26. The computer program according to claim 24, wherein one of the first map and the second map is a three-dimensional map, and the other is a two-dimensional map.
